(19) United States
(12) Patent Application Publication
(10) Pub. No.: US 2026/0296223 A1
(43) Pub. Date: Oct. 1, 2026

(54) MOBILE BATTERY AND/OR A BATTERY HYBRID MOBILE ELECTRICAL POWER SUPPLY FOR ELECTRIC POWERED DRILL RIG

(71) Applicant: SANDVIK MINING AND CONSTRUCTION USA, LLC, Alachua, FL (US)

(72) Inventor: Arnold LAW, Gainesville, FL (US)

(21) Appl. No.: 19/489,126

(22) PCT Filed: May 31, 2024
(86) PCT No.: PCT/US2024/031807

§ 371 Date: Dec. 1, 2025

Related U.S. Application Data
(60) Provisional application No. 63/470,609, filed on Jun. 2, 2023.

(51) Int. Cl. B60L 50/60; B60L 50/53; B60L 50/61; B60L 58/24

(52) U.S. Cl. CPC B60L 50/66; B60L 50/53; B60L 50/61; B60L 58/24; B60L 2200/28; B60L 2200/40; B60L 2210/40; B60L 2260/32

(57) ABSTRACT

A mining vehicle includes a carriage, a drive assembly mounted on the carriage and arranged to move the carriage, at least one working device, and a detachable mobile power supply in communication with the drive assembly, the mobile power supply being arranged to operate the drive assembly to move the vehicle when connected to the drive assembly.

### TECHNICAL FIELD

The present disclosure relates to a mobile battery and or battery hybrid mobile electrical power supply for powering one or more drill rigs.

### BACKGROUND

The drilling environment is extreme and includes continuous vibration and shock drill drilling. Electric drill rigs need to be trammed or moved between locations to avoid environmental risks, i.e., during blasting of the rock the drill is moved away from the blast zone, and to continue drilling at different, numerous locations.

A current state of the art is a diesel hydraulic drive for tethered mobile electric drills. Such mobile tethered electric powered drills are connected to the electrical grid, for example, by a 300 meter (1000 ft) plus long electrical cable. To move the drill long distances, more than 300-400 meters, the drill has to be unplugged and powered, for example, by a diesel hydraulic power supply to drive the drill tracks that are hydraulically powered.

Alternatively, the drill rig is loaded on a low boy trailer and moved or dragged on a steel skid across the ground.

Drill rigs can also have on board batteries to power the rig to move to another location when not connected to the grid. However, such batteries are used less than 1% of the time and cost hundreds of thousands of dollars. Moreover, the space that the batteries claim on the drill rig is large and increases the overall cost of electric drills rigs.

Thus, there is a need for a more convenient, non-integral power source that can power one or more electric drill rigs to move such between locations without the need of cables, trailers or integral batteries.

### SUMMARY

The present disclosure relates to a battery powered and or diesel/hydrogen gas electric hybrid mobile supply power for powering a drill rig's own systems for long distance travel. The battery/power supply can power the rig when needed and can be used on multiple electric rigs.

In one embodiment a single mobile battery/power supply can move multiple electric drills.

The mobile battery/power supply solution can use existing grid power to recharge and hence be a renewable energy.

The mobile battery power supply can be self-propelled or mounted within a mobile trailer.

An autonomous self-propelled power supply can be linked with the drill to be able to self-steer with guidance from the drill.

The power supply can be a hybrid using diesel or hydrogen gas engine to power the electric rig.

The detachable mobile power supply is in communication with the drive assembly and is arranged to move the vehicle when the drive assembly is non-operational.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a side view of an electric drill rig and mobile battery/power supply of the present disclosure.

FIG. 2 is a perspective view of the mobile battery power supply of the present disclosure.

FIG. 3 is a block diagram of a mobile autonomous hybrid power supply.

### DETAILED DESCRIPTION

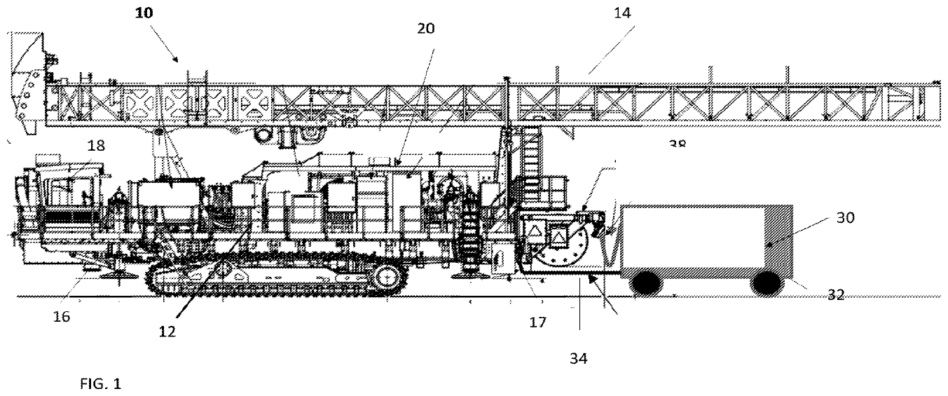

As shown in FIG. 1, a mining vehicle 10, such as a rotary electric drill rig, includes a deck or carriage 12 and a mast 14 mounted at a first end 16 of the carriage. As is known, mast 14 is movable between a horizontal, stored position and a vertical, operable position, where the work devices or drilling components carried thereon are operable. A cab 18 is also provided at first end 16. The vehicle is powered by a drive assembly 20, which includes known components and which will be discussed further herein. Vehicle 10 includes other conventional components, which will not be discussed further herein. It should also be appreciated that other types of vehicles are contemplated being powered by the present mobile battery and or battery hybrid mobile electrical power supply and the present disclosure is not limited to mining vehicles.

As discussed supra, in addition to conventional drive assembly 20, the vehicle 10 can be powered using a battery powered and/or diesel electric hybrid mobile power supply 30 for powering the drill rigs own systems for tramming or long distance travel. For example, an internal combustion engine (ICE) 46 using diesel, alternative fuels including hydrogen of an electric fuel cell using, as an example, hydrogen as a fuel.

As shown in FIG. 1, mobile power supply 30 can be removably attached to the vehicle at an end 17 thereof. The power supply in FIG. 1 is shown at the cable reel end of the drill for clarity and is not required to be at that location during movement.

Mobile power supply 30 can be mounted on a trailer 32 attachable to a hitch 34. Although illustrated as a trailer 32, which is attached to the deck 12, mobile power supply 30 can be an autonomous self-propelled power supply that is remotely operated via a control system 50 in the vehicle or in a mining environment, by an autonomously or tele-remote control system.

Mobile power supply 30 is removably attachable to the vehicle power supply via a cable 38. Hence, the vehicle can be powered when needed by the mobile power supply 30 and mobile power supply 30 is detachable so that it can be used on multiple of electric vehicles. Thus, one mobile power supply can move for example, multiple electric drill rigs.

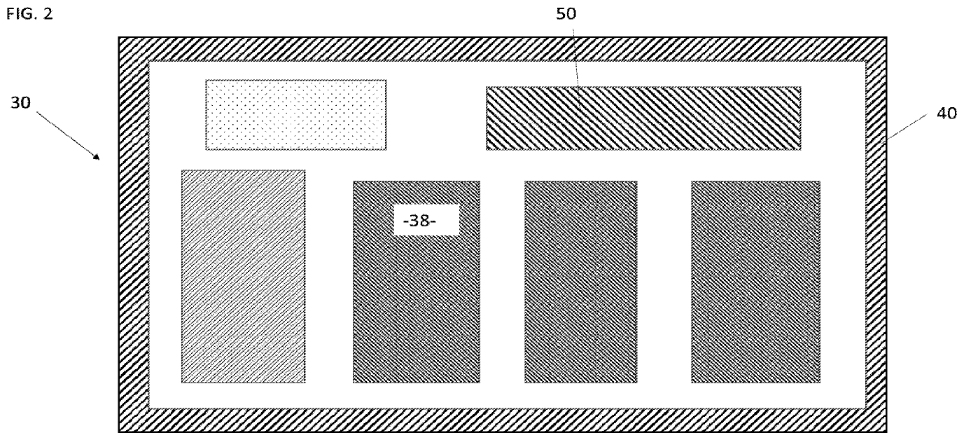

Referring to FIG. 2, mobile power supply 30 can be a battery powered system having a plurality of rechargeable batteries 38 housed in a climate controlled housing 40. Mobile power supply 30 can operate with standard electrical components, DC to AC inverter with a transformer.

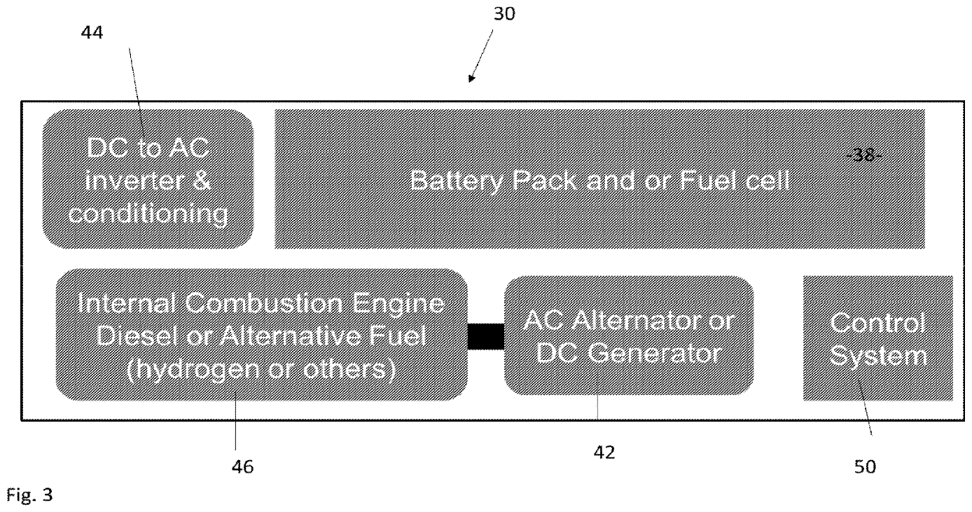

Referring to FIG. 3, mobile power supply 30 can also be a hybrid using a diesel or hydrogen powered engine 46 to power the electric drive system. In this embodiment, the power supply would be provided with components such as a DC to AC inverter and conditioning, AC alternator to DC generator 42 and control system 50.

The power supply can be located at any location by the blasthole drill. The use of cameras, GPS, proximity sensors, obstacle and cable detection sensors and mine map will allow the self-propelled autonomous and or tele-remote controlled power supply to be located at any side of the drill and at any distance required for movement to avoid collision with the drill and obstacles for example during the a turn. The cable management software along with the mentioned sensors will manage the cable to keep it in the proper position to avoid driving over the cable. The power supply in FIG. 1 is shown at the cable reel end of the drill for clarity and is not required to be at that location during movement.

In summary, expensive batteries are used only when needed and not mounted to the drill when not being used. The space claim of the batteries on the drill is large and will make electric drills more expensive. The battery solution uses grid power to recharge that can be from renewable energy. The mobile battery power supply can be self-propelled or a trailer mounted design. An autonomous self-propelled power supply can be linked with the drill to be able to self-steer and/or with guidance from the drill.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

1. A mining vehicle comprising:
a carriage;
a drive assembly mounted on the carriage and arranged to move the carriage;
at least one working device mounted on the carriage; and
a detachable mobile power supply in communication with the drive assembly, the mobile power supply being arranged to operate the drive assembly to move the vehicle when connected to the drive assembly.

2. The mining vehicle according to claim 1, wherein the mobile power supply is removably connected to the carriage.

3. The mining vehicle according to claim 1, wherein the mobile power supply is mounted on a trailer attached to the carriage.

4. The mining vehicle according to claim 1, wherein the mobile power supply is a battery powered system having a plurality of rechargeable batteries housed in a housing.

5. The mining vehicle according to claim 1, wherein the mobile power supply is a hybrid using a diesel or hydrogen powered engine arranged to power the drive system.

6. The mining vehicle according to claim 1, wherein the mobile power supply is autonomously and remotely operated by a control system.

7. The mining vehicle according to claim 1, wherein the mobile power supply is removably attachable to the drive assembly via a cable.

8. A mobile power supply system for moving an electrically powered drill rig, comprising:
a mobile power supply configured to be detachable from the drill rig;
a power cable arranged to operatively couple the mobile power supply to a drive assembly of the drill rig; and
a control system configured, when the mobile power supply is coupled via the power cable, to operate the drive assembly to move the drill rig independently of a fixed electrical grid connection.

9. The mobile power supply system of claim 8, wherein the mobile power supply comprises a battery module including a plurality of rechargeable batteries housed in a climate-controlled enclosure.

10. The mobile power supply system of claim 8, wherein the mobile power supply comprises a hybrid module including an engine configured to run on diesel or hydrogen, and a generator coupled to a power conditioning stage including a DC-to-AC inverter.

11. The mobile power supply system of claim 8, wherein the mobile power supply is mounted on a trailer and is attachable to a hitch of the drill rig.

12. The mobile power supply system of claim 8, wherein the mobile power supply is self-propelled and configured for autonomous or tele-remote operation.

13. The mobile power supply system of claim 12, wherein the self-propelled mobile power supply includes cameras, GPS, proximity sensors, obstacle sensors, cable detection sensors, and is operable in accordance with a mine map.

14. The mobile power supply system of claim 9, wherein the battery module is configured to be recharged using grid power, including renewable energy sources.

15. The mobile power supply system of claim 8, wherein the control system is located on the drill rig, or on the mobile power supply.

16. The mobile power supply system of claim 8, wherein the mobile power supply is configured for sequential use to move multiple electric drill rigs.

17. A trailer-mounted mobile power supply comprising:
a trailer chassis configured to be connected to a drill rig;
a power module selected from a battery module with a plurality of rechargeable batteries or a hybrid module including an engine and generator; and
a power interface cable configured to connect the power module to a drive assembly of the drill rig to move the drill rig when the drill rig is not connected to a fixed electrical grid.
